(19) United States
(12) Patent Application Publication
(10) Pub. No.: US 2014/0173395 A1
(43) Pub. Date: Jun. 19, 2014

(54) IMAGE PROCESSING APPARATUS, IMAGE PROCESSING METHOD, AND PROGRAM

(71) Applicant: CANON KABUSHIKI KAISHA, Tokyo (JP)

(72) Inventor: Daiki Tachi, Kawasaki-shi (JP)

(73) Assignee: CANON KABUSHIKI KAISHA, Tokyo (JP)

(21) Appl. No.: 14/097,781

(22) Filed: Dec. 5, 2013

(30) Foreign Application Priority Data
Dec. 17, 2012 (JP) 2012-274584

(51) Int. Cl. G06F 17/21

(52) U.S. Cl. CPC G06F 17/211
USPC 715/202

(57) ABSTRACT

In an image processing apparatus, it has been difficult to perform an operation to embed an object into electronic data generated by reading a document. A document is read optically and digitized in accordance with a predetermined file format, and whether there is an area into which an object can be embedded in image data obtained by digitization is determined. In a case where it is determined that there is the area into which an object can be embedded, an image representing an object is embedded into the area.

### FIELD OF THE INVENTION

The present invention relates to a technique to embed information into image data.

### DESCRIPTION OF THE RELATED ART

Electronic data formats include an electronic data format, such as a PDF (portable document file) specified by the ISO, capable of embedding an object, such as a moving image and sound, into its file. Then, embedment of an object can be executed on an application within a personal computer (PC) compatible with the electronic file.

In recent years, electronic files are generated frequently in an apparatus other than PC, such as an MFP (Multi Function Peripheral) including a scan function to optically read a document. Then, for electronic files generated in the MFP etc., it is requested to enable association with data, such as a moving image and sound, by a certain method.

As to this point, for example, Japanese Patent Laid-Open No. 2008-306294 discloses the method for attaching image data generated by an image processing apparatus to an electronic mail together with moving image data by utilizing the file attachment function of electronic mails.

At present, a PC is necessary separately from an image processing apparatus in order to embed a moving image file etc. into image data obtained by scan. Further, a compatible application (in the case where the file format of image data is the PDF, Acrobat etc.) that runs on the PC is also necessary. Then, a user is required to perform a procedure/task that takes time and effort. Specifically, the user is required to perform the following task. First, the user generates image data by scanning a document in the image processing apparatus and sends the image data to an arbitrary PC. In the PC, the user opens the received image data using a compatible application and specifies a moving image file etc. to be embedded and embeds it into the image data. Then, the user transmits the image data into which the moving image file is embedded to a target destination from the PC.

Further, the GUI and the input I/F in the general image processing apparatus, such as the MFP, have not developed to the degree of the PC, and therefore, there is such a problem that it is difficult to perform the detailed operation to specify an area at the time of embedding a moving image file etc. in an attempt to achieve the above-mentioned series of tasks only by the image processing apparatus.

### SUMMARY OF THE INVENTION

An image processing apparatus according to the present invention includes a unit configured to optically read a document and to digitize it in accordance with a predetermined file format, an area determining unit configured to determine whether there is an area into which an object can be embedded in image data obtained by the digitization, and a unit configured to, in a case where the area determining unit determines that there is the area into which an object can be embedded, embed an image representing an object into the area.

According to the present invention, it is made possible to embed data, such as a moving image file, into image data generated by an image processing apparatus by a simple operation in the image processing apparatus.

Further features of the present invention will become apparent from the following description of exemplary embodiments (with reference to the attached drawings).

### BRIEF DESCRIPTION OF THE DRAWINGS

FIG. 1 is a block diagram showing an example of a hardware configuration of an image processing apparatus according to a first embodiment;

FIG. 2 is a diagram showing a relationship between FIGS. 2A and 2B, and FIGS. 2A and 2B are flowcharts showing a flow from scan of a document to transmission of generated image data in the image processing apparatus;

FIG. 3 a diagram showing an example of a File format selection screen;

FIG. 4 is a diagram showing an example of a Transmission destination setting screen;

FIG. 5 is a diagram showing an example of an Embedment setting screen;

FIG. 6 is a diagram showing a specific example after performing area separation processing on image data;

FIG. 7 is a diagram showing an example of an Embedment page setting screen;

FIG. 8 is a diagram showing an example of an Embedment object setting screen;

FIG. 9 is a diagram showing an example of an Embedment object execution type setting screen;

FIG. 10 is a diagram showing an example of image data into which an object image is embedded;

FIG. 11 is a diagram showing a data structure of image data into which an object image is embedded;

FIG. 12 is a diagram showing an example of image data into which an object image is embedded;

FIG. 13 is a diagram showing an example of an Embedment setting screen;

FIG. 14 is a diagram showing an example of an Attachment setting screen; and

FIG. 15 is a diagram showing a data structure of image data to which an object is attached.

### DESCRIPTION OF THE EMBODIMENTS

Hereinafter, an aspect for executing the present invention is explained using the drawings.

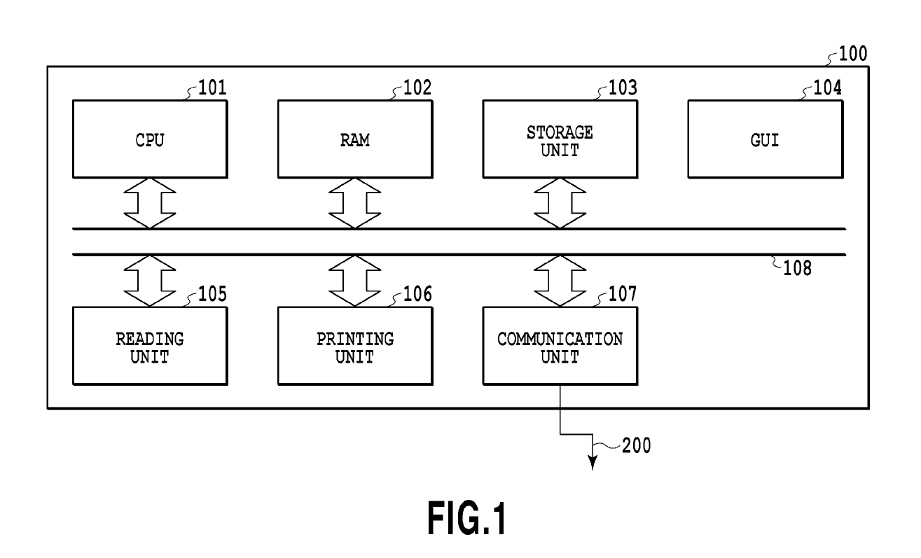

FIG. 1 is a block diagram showing an example of a hardware configuration of an MFP as an image processing apparatus according to the present embodiment.

An MFP 100 includes a CPU 101, a RAM 102, a storage unit 103, a GUI 104, a reading unit 105, a printing unit 106, and a communication unit 107, and is connected with another external device, such as a PC (not shown schematically), via a network 200.

The CPU 101 totally controls each unit by reading control programs and executing various kinds of processing.

The RAM 102 is used as a temporary storage area, such a main memory and a work area, of the CPU 101.

The storage unit 103 is used as a storage area of programs read onto the RAM, various kinds of settings, files, etc.

The GUI 104 includes a touch panel LCD display device etc. and displays various kinds of information and receives inputs of various kinds of operation instructions (commands).

The reading unit 105 optically reads a document set on a document table, not shown schematically, and generates image data (electronic file) in a predetermined format.

The printing unit 106 forms an image on a recording medium, such as paper, by using generated image data etc.

The communication unit 107 performs communication with an external device, such as a PC, via the network 200, such as a LAN.

A main bus 108 is a bus that connects each unit described above.

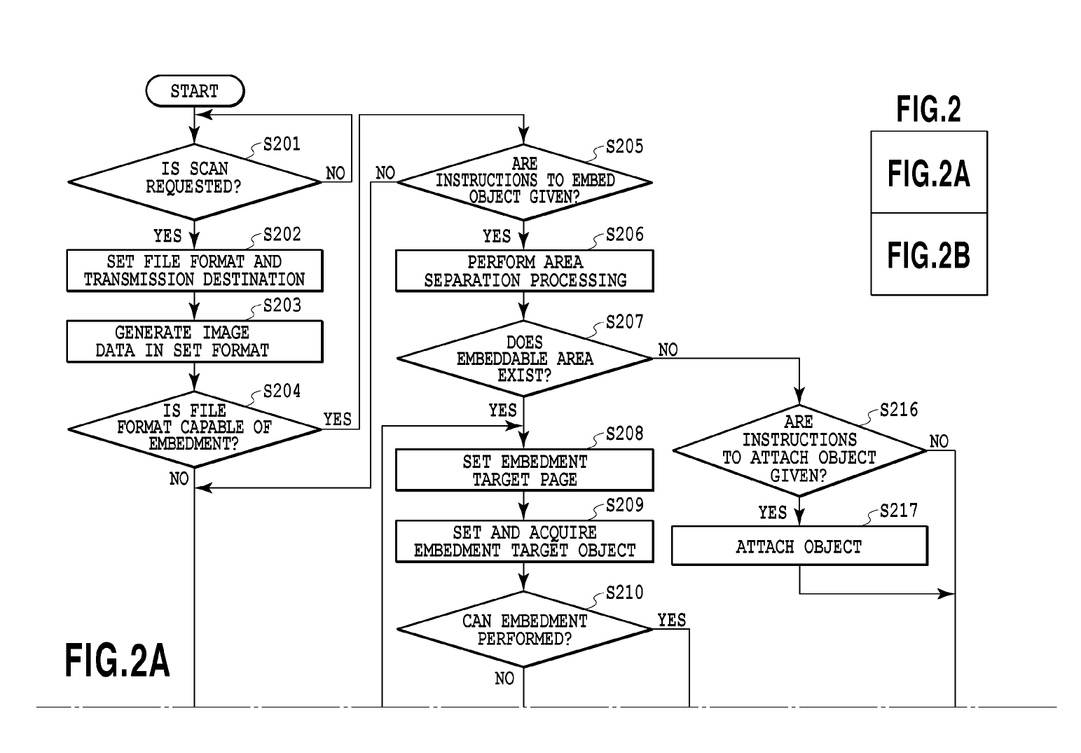

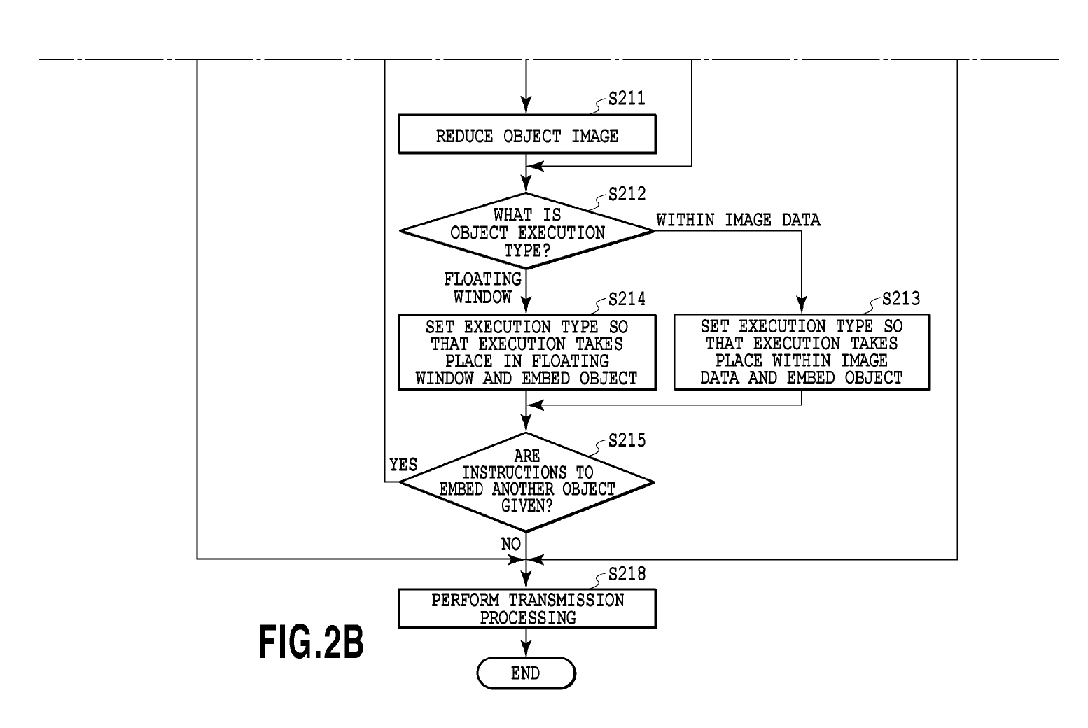

FIG. 2A and 2B are flowcharts showing a flow from scanning a document to generate image data (digitization) to transmitting the image data into which a data file (hereinafter, referred to as an “object”), such as a moving image and sound, is embedded to a predetermined destination in the MFP 100 according to the present embodiment. The series of processing is executed by the CPU 101 executing computer executable programs in which the procedure shown below is described after reading the programs from the storage unit 103 onto the RAM 102.

At step 201, the CPU 101 determines whether there is a scan request from a user via the GUI 104. In the case where there is a scan request, the procedure proceeds to step 202. On the other hand, in the case where there is no scan request, the CPU 101 stands by until a scan request is made.

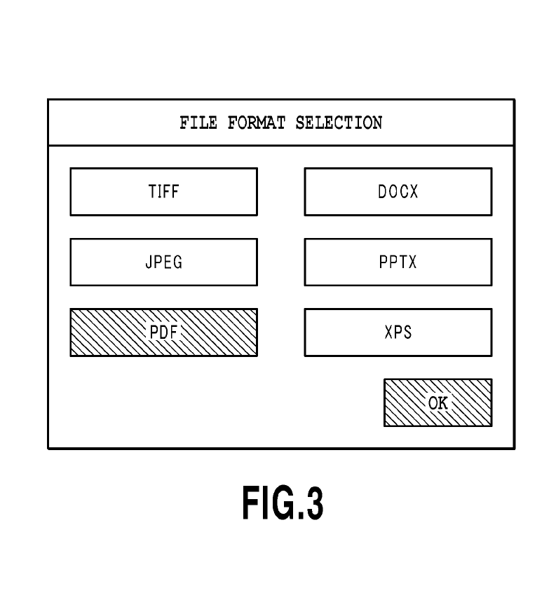

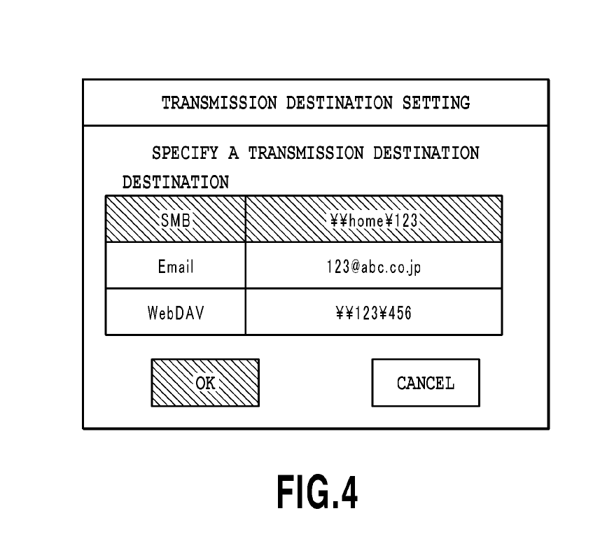

At step 202, the CPU 101 sets a file format at the time of digitization and its transmission destination. This setting is performed in accordance with selection of a user made on a screen for selecting a file format (File format selection screen) and a screen for setting a transmission destination of generated image data (Transmission destination setting screen) displayed on the GUI 104. FIG. 3 is a diagram showing an example of the File format selection screen and shows a state where a file format “PDF” is selected. FIG. 4 is a diagram showing an example of the Transmission destination setting screen and shows a state where a destination “SMB” whose address is “YYhomeY123” is specified as a transmission destination. A user specifies a file format of image data to be generated and its transmission destination by using these screens displayed on the GUI 104.

At step 203, the CPU 101 instructs the reading unit 105 to read (scan) a document and the reading unit 105 scans the document and generates image data in accordance with a file format selected via the GUI 104.

At step 204, the CPU 101 determines whether the file format of the generated image data is a file format capable of embedding an object. This format determination is performed by, for example, referring to a determination table (table associated with information, such as a flag, indicating whether embedment can be performed for each file format) stored in the storage unit 103. For example, in FIG. 3 described previously, as selectable formats, six kinds of formats, that is, “TIFF”, “JPEG”, “PDF”, “DOCK”, “PPTX”, and “XPS” are shown. In this case, a flag indicating that embedment can be performed is attached only to “PDF”, which is a format capable of embedding an object, and a flag indicating that embedment cannot be performed is attached to the other formats incapable of embedding an object. It is matter of course that in the case where a file format is added to the file formats that a user can select or a file format is changed, the contents of the determination table are changed accordingly. As a result of the determination, in the case where the file format is capable of embedding an object, the procedure proceeds to step 205. On the other hand, in the case where the file format is incapable of embedding an object, the procedure proceeds to step 218.

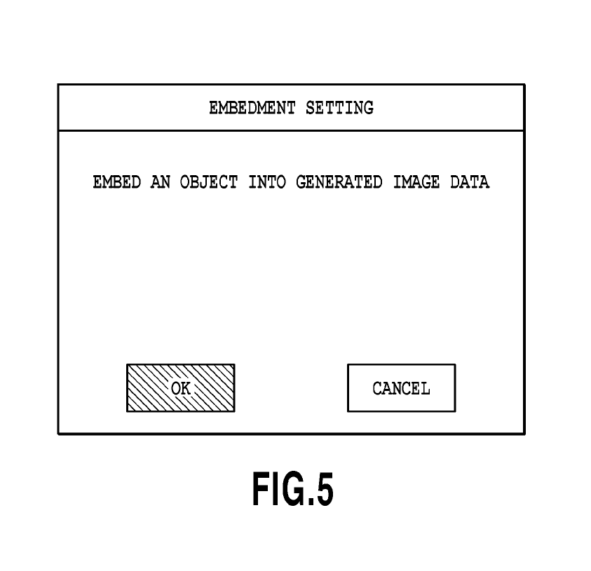

At step 205, the CPU 101 determines whether a user has given instructions to embed an object into the generated image data. The user's instructions whether to embed the object into the image data are given via the Embedment setting screen displayed on the GUI 104. FIG. 5 is a diagram showing an example of the Embedment setting screen. In the case where a user desires embedment, the user presses the OK button on the Embedment setting screen displayed on the GUI 104 and in the case where the user does not desire embedment, the user presses the Cancel button, thereby giving instructions whether to embed the object into the generated image data. Then, in the case where the pressed button is the OK button, the procedure proceeds to step 206. On the other hand, in the case where the pressed button is the Cancel button, the procedure proceeds to step 218.

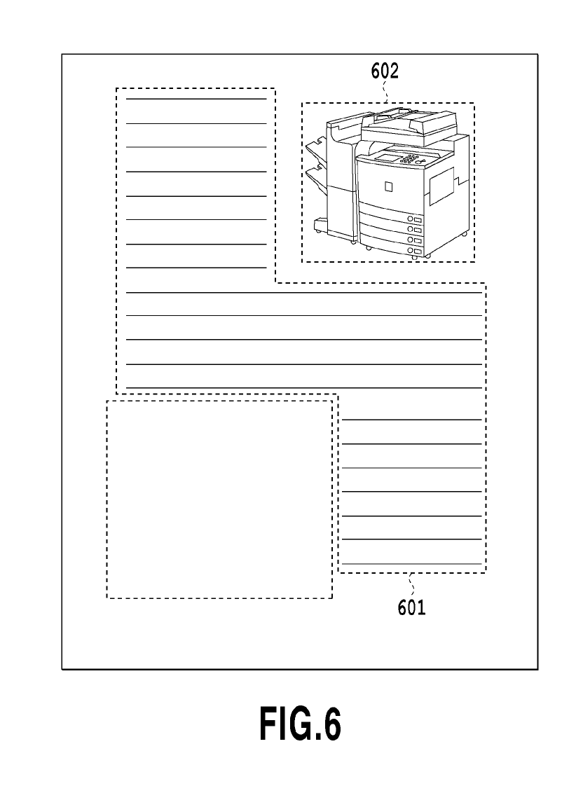

At step 206, the CPU 101 performs area separation processing on the image data obtained by scan. The area separation processing is a technique to separate image data into a character area, a figure area, an image area, another area (such as an area in which color does not change or changes slightly like a blank area (area in which the amount of change is equal to or less than a fixed value)), etc, for each attribute. FIG. 6 is a diagram showing a specific example after the area separation processing is performed on the image data. In this example, the image data is separated into three areas, that is, a character area 601, a figure area 602, and a blank area 603. The area separation processing is not the feature of the present invention, and therefore, detailed explanation thereof is omitted.

At step 207, the CPU 101 determines whether there exists an area into which an object can be embedded (hereinafter, referred to as an “embeddable area”) in each area extracted by the area separation processing for each page included in the image data. This area determination is performed, for example, based on whether the above-described area specified in advance as an embeddable area and in which the amount of change is small, or the blank area exists. In the case where there are one or more pages determined to have an embeddable area, the procedure proceeds to step 208. On the other hand, in the case where it is determined that there is no page having an embeddable area, the procedure proceeds to step 216.

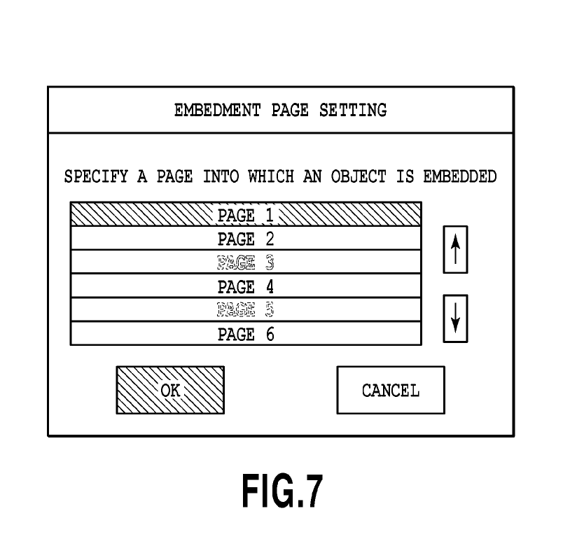

At step 208, the CPU 101 sets a page of the generated image data into which an object is embedded (embedment destination of an object). This setting is performed in accordance with selection of a user made on a screen for specifying an embedment target page (Embedment page setting screen) displayed on the GUI 104. FIG. 7 is a diagram showing an example of the Embedment page setting screen. Here, each page excluding page 3 and page 5, which are pages determined to have no area for embedding an object (object unembeddable page), is shown in the selectable state, and a state where page 1 is specified as an embedment target page is shown. In the case where the generated image data includes one page, this step is skipped.

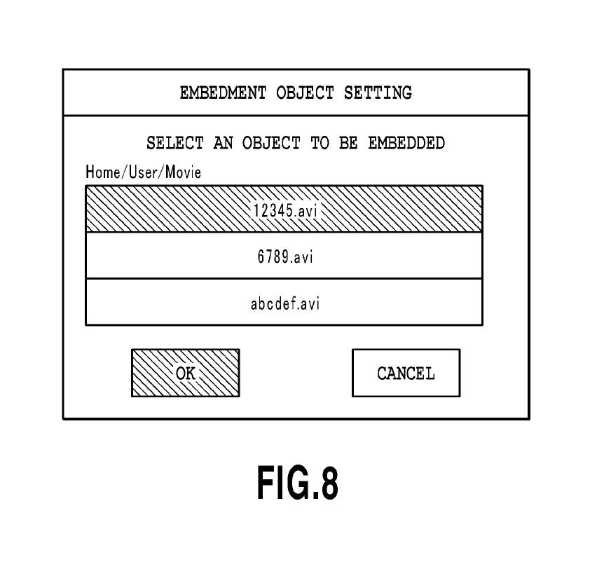

At step 209, the CPU 101 sets an object to be embedded (target object) into the set page. This setting is performed in accordance with selection of a user made on a screen for specifying a moving image file, a sound file, etc., to be embedded (Embedment object setting screen) displayed on the GUI 104. FIG. 8 is a diagram showing an example of the Embedment object setting screen. The file names of moving image files and sound files, which are embodiment target candidates, are displayed in a list and here, a state where a moving image file whose file name is “12345.avi” is specified as a target object is shown. At this time, it may also be possible to set an upper limit in advance to the file size of the embeddable object to prevent an object whose size exceeds the set file size from being specified. Then, the CPU 101 acquires the data of the specified target object. At this time, it may also be possible to acquire data of a moving image file, a sound file, etc., which may become an embedment target from the storage unit 103 within the image processing apparatus, or to acquire it from an external storage device etc. connected with the image processing apparatus.

At step 210, the CPU 101 compares the embeddable area extracted at step 206 and the area of the image representing the target object set at step 209 and including a reproduction button for the object (hereinafter, referred to as an “object image”). Then, the CPU 101 determines whether there is a sufficient space for embedding the object image within the embeddable area. This determination is performed by, for example, sequentially checking whether a rectangular area the same size as the object image (for example, 640×480 pixels) is included in the embeddable area from the end of the embeddable area. In the case where it is determined that there is a sufficient space for embedding the object image within the embeddable area, the procedure proceeds to step 212. On the other hand, in the case where it is determined that there is not a sufficient space for embedding the object image within the embeddable area, the procedure proceeds to step 211.

At step 211, the CPU 101 performs conversion processing to reduce the object image (to reduce the number of pixels) so that the object image is included within the embeddable area. At this time, it is desirable to set in advance to which extent the object to be embedded can be reduced for each type of the object. For example, in the case of a moving image film, 320×240 pixels are set as the lower limit value, in the case of a sound file, 32×32 pixels are set, and so on. Then, it may also be possible to cause the procedure to proceed to step 216, to be described later, in the case where the size of the extracted embeddable area is smaller than the lower limit value.

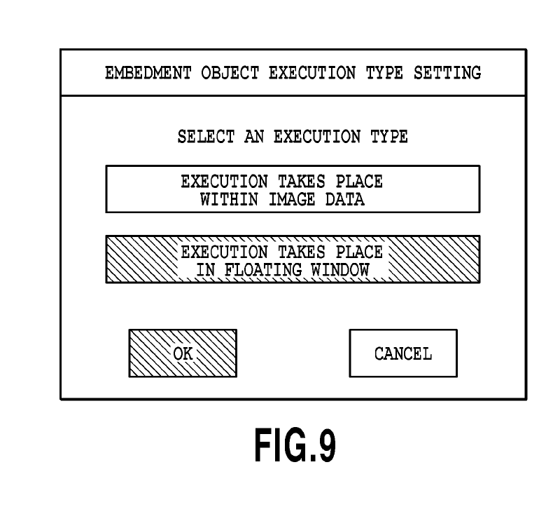

At step 212, the CPU 101 determines whether a floating window is specified as the execution type of the target object. The specification of the execution type of the target object is performed in accordance with selection of a user made on a screen for specifying an execution type of a moving image file etc. to be embedded (Embedment object execution type setting screen) displayed on the GUI 104. FIG. 9 is a diagram showing an example of the Embedment object execution type setting screen. As execution type candidates of the object to be embedded, execution in the area of the embedded object image and execution in a different area (floating window) are displayed and here, the state is shown where the execution in the floating window is specified. In the case where the execution in the area of the embedded object image is specified as the execution type, the procedure proceeds to step 213 and in the case where the execution in the floating window is specified, the procedure proceeds to step 214.

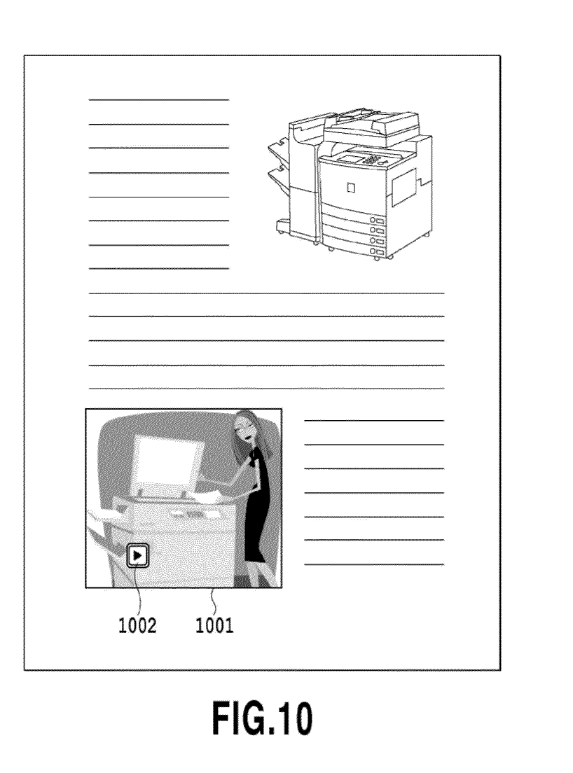

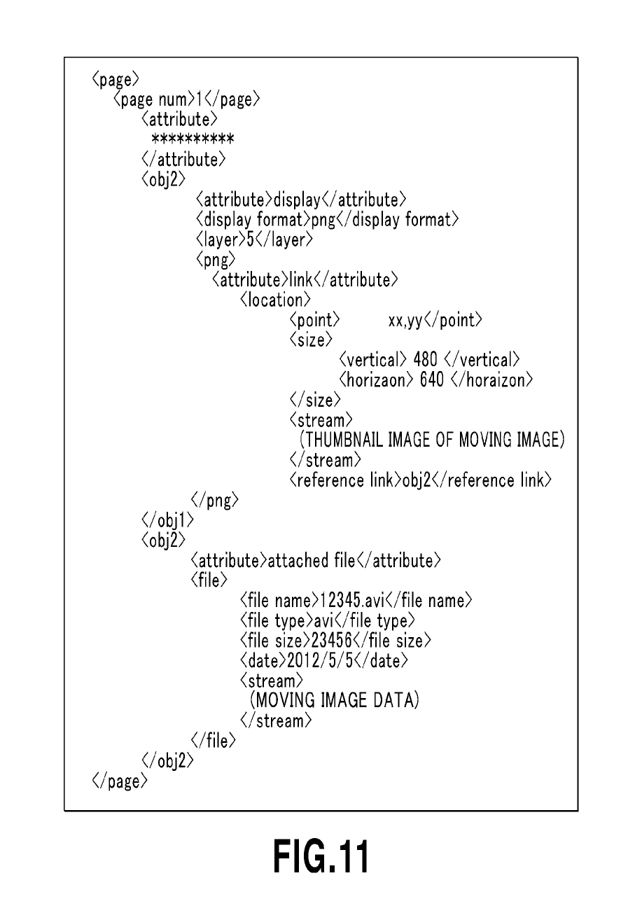

At step 213, the CPU 101 performs settings in the meta information of the object to be embedded so that the execution takes place in the area of the object image at the time of the execution, and embeds the object image into the embeddable area on the page specified at step 208. FIG. 10 is a diagram showing an example of the image data into which an object image 1001 representing a moving image file is embedded, and FIG. 11 is a diagram showing its data structure. Into the blank area 603 shown in FIG. 6, the object image 1001 (640×480) representing the moving image file whose file name is “12345.avi” is embedded. In the case where a reproduction button 1002 within the object image 1001 shown in FIG. 10 is pressed, the moving image is reproduced within the area of the object image.

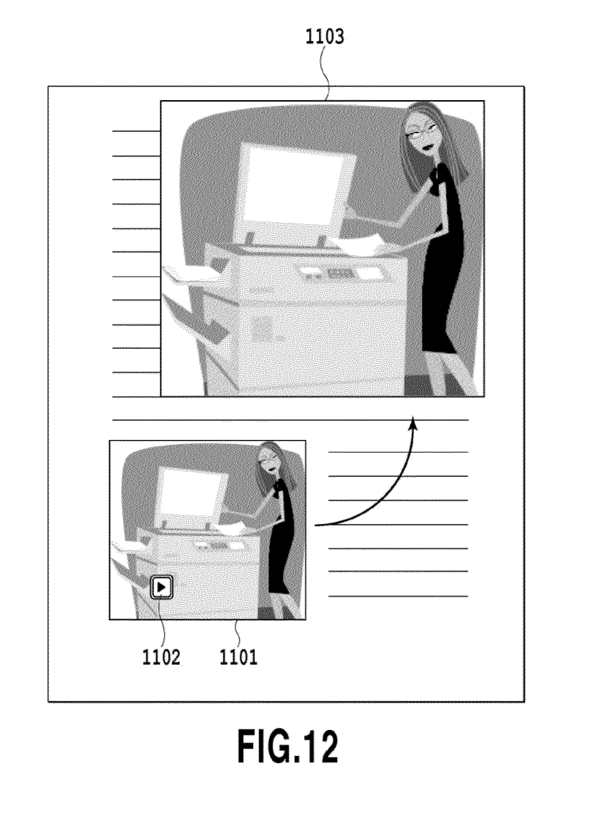

At step 214, the CPU 101 performs settings in the meta information of the object to be embedded so that the execution takes place in the floating window at the time of the execution, and embeds the object image into the embeddable area on the page specified at step 208. FIG. 12 is a diagram showing an example of the image data into which an object image 1101 representing a moving image file is embedded. Into the blank area 603 shown in FIG. 6, the object image 1101 representing a moving image file is embedded and in the case where a reproduction button 1102 is pressed, the moving image is reproduced in another window 1103 in a position (here, in the upper-right position) different from the position of the object image.

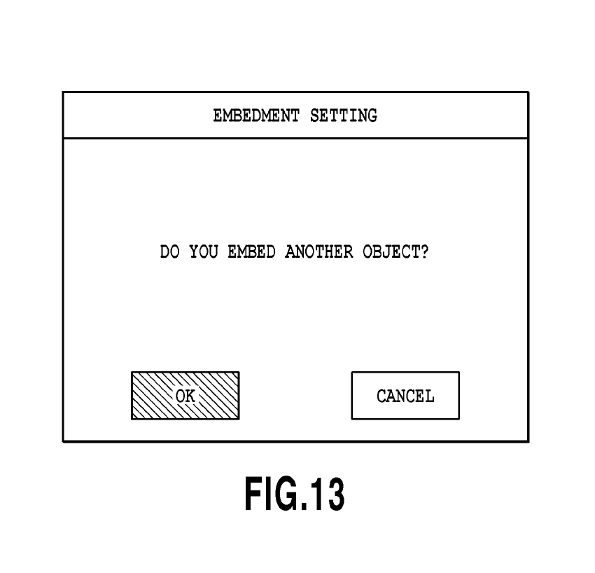

At step 215, the CPU 101 determines whether the user has further given instructions to embed another object. The user's instructions whether to embed another object are given via the Embedment setting screen displayed on the GUI 104. FIG. 13 is a diagram showing an example of the Embedment setting screen and the user gives instructions whether to embed another object by pressing the OK button in the case where the user further desires embodiment, or by pressing the Cancel button in the case where not. Then, in the case where the pressed button is the OK button, the procedure returns to step 208 and the processing at step 208 and subsequent steps is repeated. On the other hand, in the case where the pressed button is the Cancel button, the procedure proceeds to step 218.

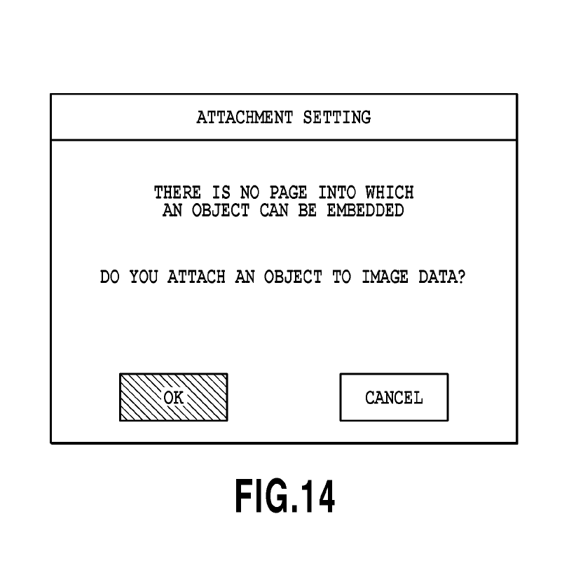

At step 216, the CPU 101 determines whether the user has given instructions to attach an object to a generated electronic file. The user's instructions whether to attach the object to the electronic file are given via an Attachment setting screen displayed on the GUI 104. FIG. 14 is a diagram showing an example of the Attachment setting screen. In the Attachment setting screen displayed on the GUI 104, the user gives instructions whether to attach the object to the generated electronic file by pressing the OK button in the case where the user desires to attach the object, or by pressing the Cancel button in the case where the user does not desire to attach the object. Then, in the case where the pressed button is the OK button, the procedure proceeds to step 217. On the other hand, in the case where the pressed button is the Cancel button, the procedure proceeds to step 218.

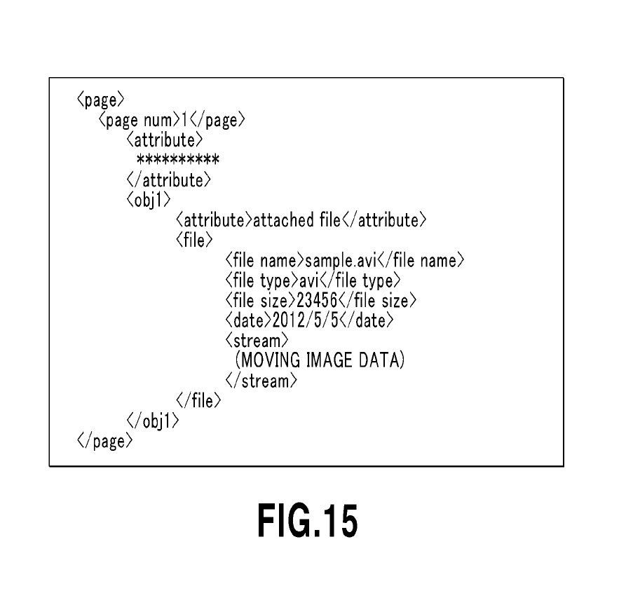

At step 217, the CPU 101 displays an Attachment object setting screen (not shown schematically) similar to FIG. 8 described previously and attaches an object, such as a moving image file selected by the user, to the generated electronic file. FIG. 15 is a diagram showing an example of the data structure of the image data to which the moving image file is attached as the object.

At step 218, the CPU 101 instructs the communication unit 107 to transmit the generated image data to a specified transmission destination. In the case of the present embodiment, any of the image data into which the object is embedded (steps 213, 214), the image data to which the object is attached (step 217), and the image data into which no object is embedded and to which no object is attached (No at step 204 or 205) is transmitted.

In the flowchart shown in FIG. 2A, the question of whether to proceed to the processing to embed an object depends on whether there is an embeddable area (step 207). Instead of this, it may also be possible to set in advance the file size (for example, 10 MB) of the object that can be embedded and to cause whether to proceed to the processing to depend on whether the file size of the specified object to be embedded exceeds the set file size.

Further, in the flowchart shown in FIGS. 2A and 2B, it is premised that the file format capable of embedding an object is also capable of attaching a file, and the file format incapable of embedding a file is also incapable of attaching a file. In the case where there may be a file format incapable of embedding a file but capable of attaching a file, it is only required to modify the flowchart accordingly. Fore example, processing to determine “whether the file format is capable of attaching an object” is added after No is determined at step 204 or step 205, and in the case of Yes, the procedure proceeds to step 216, and so on.

By the processing as described above, it is made possible for a user to embed an object, such as a moving image and sound, into image data generated by scan without requiring the user to perform complicated operations on the GUI and the input I/F on the image processing apparatus.

Further, it is also possible to make use of the various functions (specification of a transmission destination in the transmission address list, electronic signature function, etc.) of the image processing apparatus for the image data into which an object is embedded, and therefore, the convenience of the user is further improved.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-274584, filed Dec. 17, 2012, which is hereby incorporated by reference herein in its entirety.

What is claimed is:

1. An image processing apparatus comprising:
a unit configured to optically read a document and to digitize it in accordance with a predetermined file format;
an area determining unit configured to determine whether there is an area into which an object can be embedded in image data obtained by the digitization; and
a unit configured to, in a case where the area determining unit determines that there is the area into which an object can be embedded, embed an image representing an object into the area.

2. The image processing apparatus according to claim 1, further comprising a unit configured to separate the image data into areas for each attribute, wherein
the area determining unit determines an area in which an amount of change in color is equal to or less than a fixed value among the separated areas for each attribute, as the area into which an object can be embedded.

3. The image processing apparatus according to claim 1, wherein
the area in which the amount of change in color is equal to or less than a fixed value is a blank area.

4. The image processing apparatus according to claim 1, further comprising:
a display unit configured to display a setting screen for a user to specify the predetermined file format; and
a format determining unit configured to determine whether or not the predetermined file format specified by a user is a file format capable of embedding an object, wherein
the area determining unit determines, in a case where it is determined that the predetermined file format specified by a user is a file format capable of embedding an object, whether there is the area into which an object can be embedded in the image data.

5. The image processing apparatus according to claim 1, wherein
the display unit displays a setting screen for a user to specify the object.

6. The image processing apparatus according to claim 1, further comprising a unit configured to reduce the image representing an object so that the image representing the object is included in an area determined to be capable of embedding the object in a case where the image representing the object is not included in the area determined to be capable of embedding the object by the area determining unit.

7. The image processing apparatus according to claim 6, wherein
a lower limit of a size of the image representing an object is set in advance for each type of an object to be embedded.

8. The image processing apparatus according to claim 1, wherein
the display unit displays a setting screen for specifying an execution type of the object, and
the object is embedded in accordance with a specified execution type.

9. The image processing apparatus according to claim 8, wherein
the execution type is a type in which execution takes place in an area of the image representing an object.

10. The image processing apparatus according to claim 8, wherein
the execution type is a type in which execution takes place in an area different from the image representing an object.

11. The image processing apparatus according to claim 1, further comprising a unit configured to attach an object to the image data in a case where the area determining unit determines that there is not an area into which the object can be embedded.

12. The image processing apparatus according to claim 1, wherein
the object is a moving image file or a sound file.

13. An image processing method comprising the steps of:
optically reading a document and digitizing it in accordance with a predetermined file format;
determining whether there is an area into which an object can be embedded in image data obtained by the digitization; and
embedding, in a case where it is determined that there is the area into which an object can be embedded in the area determining step, an object into the area.

14. A non-transitory computer readable storage medium storing a program for causing a computer to perform the image processing method according to claim 13.
